(19) United States
(12) Patent Application Publication
(10) Pub. No.: US 2024/0378045 A1
(43) Pub. Date: Nov. 14, 2024

(54) MOBILE INDUSTRIAL SYSTEM EMBEDDED CONTENT UNLOCKING AND NEW CONTENT INSTALLATION

(71) Applicant: Rockwell Automation Technologies, Inc., Mayfield Heights, OH (US)

(72) Inventors: Marius G. CHIS, Cambridge (CA); Jonathan A. MILLS, Mayfield Heights, OH (US); Todd A. WIESE, Hubertus, WI (US)

(21) Appl. No.: 18/316,290

(22) Filed: May 12, 2023

(51) Int. Cl. G06F 8/65; G06F 21/10

(52) U.S. Cl. CPC G06F 8/65; G06F 21/1011

(57) ABSTRACT

A method includes connecting a mobile device to an intelligent industrial device of an industrial system, and using the mobile device, one of: enabling embedded content of the intelligent industrial device; and installing new content in the intelligent industrial device. A non-transitory computer readable medium has computer executable instructions which, when executed by a processor of a mobile device connected to an industrial network of an industrial system, cause the mobile device to enable embedded content of an intelligent industrial device of the industrial system, or install new content in the intelligent industrial device.

### BACKGROUND INFORMATION

The subject matter disclosed herein relates to industrial systems and apparatus.

### BRIEF DESCRIPTION

In one aspect, a method includes connecting a mobile device to an intelligent industrial device of an industrial system, and using the mobile device, one of: enabling embedded content of the intelligent industrial device; and installing new content in the intelligent industrial device.

In another aspect, a non-transitory computer readable medium has computer executable instructions which, when executed by a processor of a mobile device connected to an industrial network of an industrial system, cause the mobile device to enable embedded content of an intelligent industrial device of the industrial system or install new content in the intelligent industrial device.

In a further aspect, a mobile device includes a memory that stores executable components and a processor operatively coupled to the memory and configured to execute the executable components, where the executable components includes a communications component that communicates with an intelligent industrial device of an industrial system via a human interface module or a wireless access point or an industrial network of the industrial system, and a content component that installs or triggers installation of new content to the intelligent industrial device or enables embedded content of the intelligent industrial device.

### BRIEF DESCRIPTION OF THE DRAWINGS

FIG. 1 is a system diagram of an industrial system.

FIG. 1A is a schematic diagram of a human interface module of the industrial system.

FIG. 1B is a schematic diagram of a mobile device operatively coupled to the industrial system.

FIG. 2 is a flow diagram of a method.

### DETAILED DESCRIPTION

Referring now to the figures, several embodiments or implementations are hereinafter described in conjunction with the drawings, wherein like reference numerals are used to refer to like elements throughout, and various features are not necessarily drawn to scale.

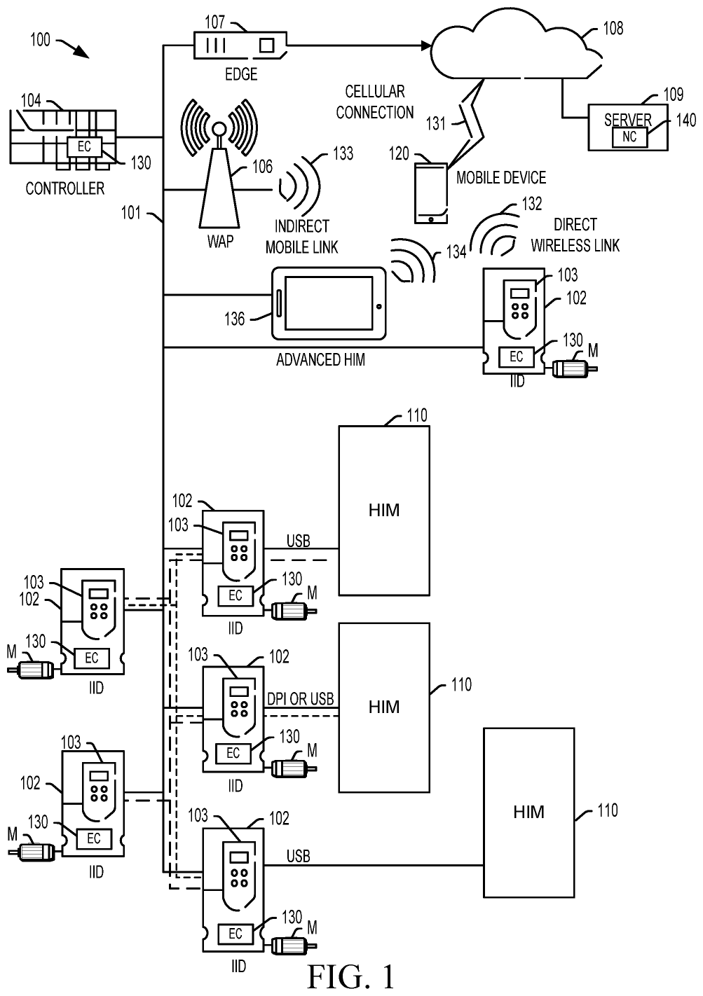

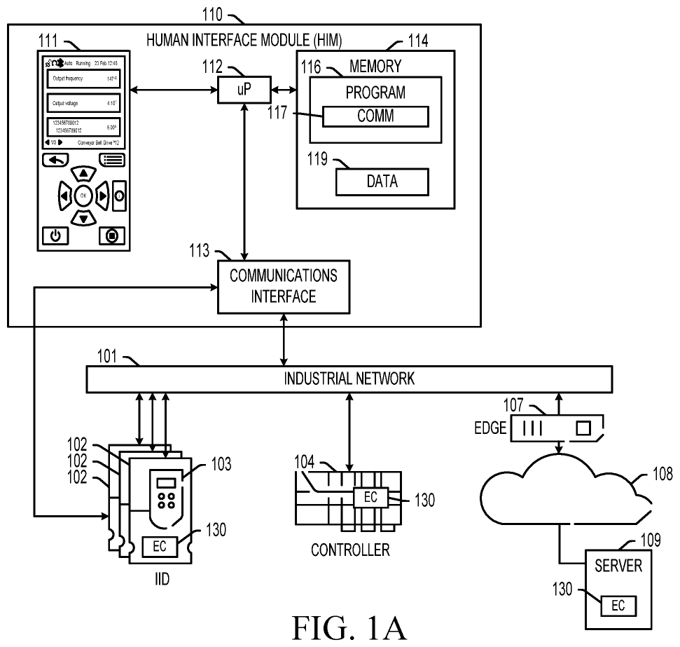

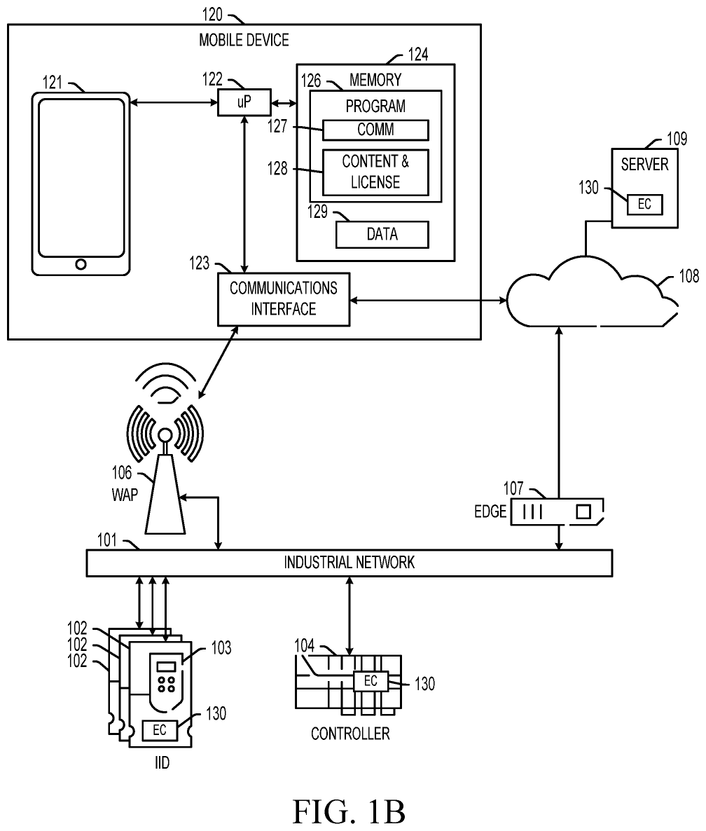

FIG. 1 shows an industrial system 100 having an industrial network 101 and intelligent industrial devices (IID) 102 (e.g., labeled IID in FIG. 1) operatively connected to the industrial network 101. The illustrated system 100 has various possible components, but the illustrated and described components are not all necessary for a given implementation and other system implementations can have more, fewer and/or different components depending on the application. The system 100 also includes one or more human interface modules 103 (also referred to as HIMs) operatively coupled to an associated one of the intelligent industrial devices 102 and/or to the industrial network 101. The industrial network 101 can be or include any suitable type and form of communications network with communications lines and equipment, wired and/or wireless, communications bridging equipment, etc., for example industrial Ethernet or Ethernet/IP, fieldbus compliant networks, etc., configured to support communications between connected devices and systems using one or more protocols, and may include bridges or adapters for interfacing devices communicating on different protocols. The intelligent industrial devices 102 can be any form or type of industrial control component or system, for example, motor drives operative to drive a motor load M as schematically illustrated in FIG. 1, power supplies, other types and forms of industrial control equipment, etc. The industrial system 100 may also include one or more controllers 104 (e.g., rack mounted modules programmable logic controllers (PLCs), I/O modules, etc.) operatively coupled to the industrial network 101, a wireless access point (WAP) 106 operatively coupled to the industrial network 101, and a network edge device 107 operatively coupled with the industrial network 101 to provide communications between the industrial network 101 and a cloud connection 108 to a server 109 and/or other external networks, components and/or systems (not shown). The industrial system 100 and the components thereof provide control and actuator functions to operate an industrial system, such as a manufacturing facility or machines thereof, such as conveyors, motors, valves, power supplies, etc., including operation of one or more connected or independent control loops implemented by processors (not shown) of one or more of the intelligent industrial devices 102, the controller 104, and/or of a remote system such as the cloud-based server 109. In certain implementations, one or more of the intelligent industrial devices 102 and/or the controller 104 include respective embedded content 130 (e.g., labelled “EC” in FIG. 1), and/or the cloud-based server 109 includes new content 140 (e.g., labelled “NC” in FIG. 1). The embedded content EC 130 and the new content NC 140 include executable code or components and/or data and/or functionality that can be implemented by an intelligent industrial device 102 when enabled or installed therein.

The industrial system 100 in one example also includes intelligent HIMs 110 operatively coupled to an associated one of the intelligent industrial devices 102 and/or to the industrial network 101. The HIMs 110 can include human-machine interface devices and systems, such as displays, keyboards or keypads, speakers, microphones, etc. FIG. 1A illustrates an example HIM 110 of the industrial system 100. FIG. 1 further illustrates a mobile device 120 that can be operatively coupled to the devices 102 and other components of the system 100 and to the industrial network 101 by various structures, for example, cellular or other wired or wireless connections to the industrial network 101 via the cloud connection 108 and the network edge device 107 (shown as an optional cellular connection 131 in FIG. 1), wired or wireless connections to one of the intelligent industrial devices 102 and/or to an associated HIM 103 (e.g., shown as a direct wireless link 132 in FIG. 1), a wireless connection via the WAP 106 (e.g., shown as an indirect mobile link 133 in FIG. 1), and/or a wireless connection 134 established between the mobile device 120 and an advanced HIM 136, such as a tablet device operatively coupled by wired or wireless communications to the industrial network 101 as shown in FIG. 1. FIG. 1B shows an example implementation of the mobile device 120 operatively coupled to the industrial system 100.

As shown in the example of FIG. 1A, the intelligent HIMs 110 include an operator or user interface 111, having a graphic and/or textual visual display and various keypad buttons to allow a user to interact with the HIM 110 and an associated one of the intelligent industrial devices 102, as well as a processor 112 operatively coupled with a communications interface 113 operatively coupled with the industrial network 101 and with an associated intelligent industrial device 102, as well as an electronic memory 114. The electronic memory 114 includes processor executable instructions to implement a program 116, including a communications component 117, as well as data storage 119. The program instructions 116 in one example implement the functions described herein. In operation, the HIM 110 communicates with one or more of the intelligent industrial devices 102 and/or associated local HIMs 103, as well as with the controller 104 and/or the cloud-based server 109 via the cloud connection 108 as schematically illustrated in FIG. 1A.

FIG. 1B illustrates an example implementation of the mobile device 120. The mobile device 120 can be any form of portable electronic device, such as a tablet, smart phone, smart watch, etc. The illustrated example mobile device 120 includes a user interface 121, such as a touchscreen allowing a user to interact with one or more apps or programs installed in the mobile device 120. The mobile device 120 includes a processor 122 operatively coupled with a communications interface 123. The communications interface 123 is operatively coupled with the industrial network 101 for wired or wireless communications there between. The processor 122 is operatively coupled to an electronic memory 124. The electronic memory 124 is a non-transitory computer readable medium that includes processor or computer executable instructions to implement a program 126, including a communications component 127 and a content component 128, as well as data storage 129. The computer executable program instructions 126 in one example implement an app to perform the functions described herein, and a user can download the app to the mobile device 120. In operation, the mobile device 120 communicates with one or more of the intelligent industrial devices 102 and/or associated local HIMs 103, as well as with the controller 104 and/or the cloud-based server 109 via the cloud connection 108 as schematically illustrated in FIG. 1A. The mobile device 120 in one implementation can communicate with the intelligent industrial devices 102 either directly (e.g., via Bluetooth) or by accessing the industrial network 101 through the WAP 106 and browsing for intelligent industrial devices 102. The cloud connection 108 in one example facilitates accessing data uploaded to the cloud by the intelligent industrial devices 102 via the edge device 107. The cloud connection 108 in one example does not allow the mobile device 120 to interact with intelligent industrial devices 102 directly, although not a strict requirement of all possible implementations. In the illustrated example, the mobile device 120 can communicate with the cloud-based server 109 either directly by cellular connection to the cloud connection 108 and/or through the industrial network 101. The industrial network 101 is configured to connect mobile device 120 to the industrial system 100 and devices and components of the system 100 via the edge device 107.

The computer executable program instructions 126 in the electronic memory 124, when executed by the processor 122 of the mobile device 120, cause the mobile device 120 to enable embedded content 130 of an intelligent industrial device 102 of the industrial system 100 and/or to install new content 140 in the intelligent industrial device 102. The mobile device processor 122 is operatively coupled to the memory 124 and configured to execute the executable components 126, including the communications component 127 that communicates with an intelligent industrial device 102 of the industrial system 100 via an associated human interface module 110 or the wireless access point 106 or via the industrial network 101, as well as the content component 128 that installs or triggers installation of the new content 140 to the intelligent industrial device 102 or enables embedded content 130 of the intelligent industrial device 102. Execution of the computer executable instructions 126 in one example cause the mobile device 120 to obtain a license for the embedded content 130 and/or the new content 140 of the intelligent industrial device 102. In one example, execution of the computer executable instructions 126 can cause the mobile device 120 to enable the embedded content 130 of the intelligent industrial device 102 and/or to install the new content 140 in the intelligent industrial device 102.

In various implementations, the mobile device 120 with an app, upon connecting to the industrial system 100 and the industrial network 101, for example, via a HIM 110 or the WAP 106, can activate the new content 140 or trigger delivery of the new content 140 such as functionality through an alternate path like containerized content from the cloud-based server 109 via the cloud connection 108 to the intelligent industrial device 102. The mobile device 120 in certain examples can obtain a license to enable content delivery and/or activation (e.g., downloading and installation). In some examples, the mobile device 120 can enable (e.g., unlock) content such as embedded content 130 functionality that is already present in the intelligent industrial device 102 as shown in FIG. 1. In this or another example, the mobile device 120 can trigger delivery (e.g., installation) of the new content 140 such as functionality that is stored in the cloud-based server 109 in FIG. 1. The cloud-based server 109 can store a container of functionality that can be executed in the intelligent industrial devices 102 and has to be deployed (e.g., downloaded directly or indirectly and installed) in the intelligent industrial device 102.

The content delivery/installation and/or enablement can be contingent on a license in certain examples. The mobile device 120 can download new content 140 or a license to the intelligent industrial device 102 or initiate (e.g., trigger) downloading of new content 140 and/or a license to the intelligent industrial device 102 from an external source, such as from the cloud-based server 109. The downloaded or enabled new content 140 in certain examples can be motor control functionality, such as motor control capability or analytic capability that can be executable by the intelligent industrial device 102 and/or a designated/configured chainable compute resource or service. The mobile device 120 in certain examples can indicate the availability of locked or downloadable new content 140 such as functionality and/or any require license to a user of the mobile device 120.

The mobile device 120 in certain examples can connect with the cloud via a wireless connection (e.g., the connections 131-134 in FIG. 1, such as via a HIM 110 or advanced HIM 136, the WAP 106, etc.) to the industrial network 101 and/or can access the cloud management function via secure cellular communications, and the mobile device 120 can manage the downloading, enabling and/or licensing of the desired content 130, 140. In certain examples where the intelligent industrial device 102 is in a location with no network access (e.g., no cloud access) and/or the intelligent industrial device 102 is not managed by the cloud, the mobile device 120 can download the executable code of the new content 140 into the mobile device 120, for example, via cellular communications (or beforehand) and then the mobile device 120 can directly deploy the new content 140 and/or a license to the intelligent industrial device 102 through a direct connection to the intelligent industrial device 102 (e.g., via an associated HIM 110, 136 or the WAP106), including possible use of the industrial network 101.

The mobile device 120 can manage content download, enablement and/or licensing for multiple intelligent industrial devices 102, for example, a cluster of drives 102, and enable embedded content 130 and/or add a new function 140 for an entire line of drive intelligent industrial devices 102, for example, by downloading or managing a function and/or licenses as a batch to update an entire line of an industrial system 100. The new content 140 can include device configurations and/or firmware updates, for example, a configuration file or firmware update that gets downloaded to all of the intelligent industrial devices 102, or such downloads can be managed using the cloud connection 108, for example, with the mobile device 120 interacting with the cloud-based server 109 via the network 101 and the cloud connection 108 and/or by cellular communications.

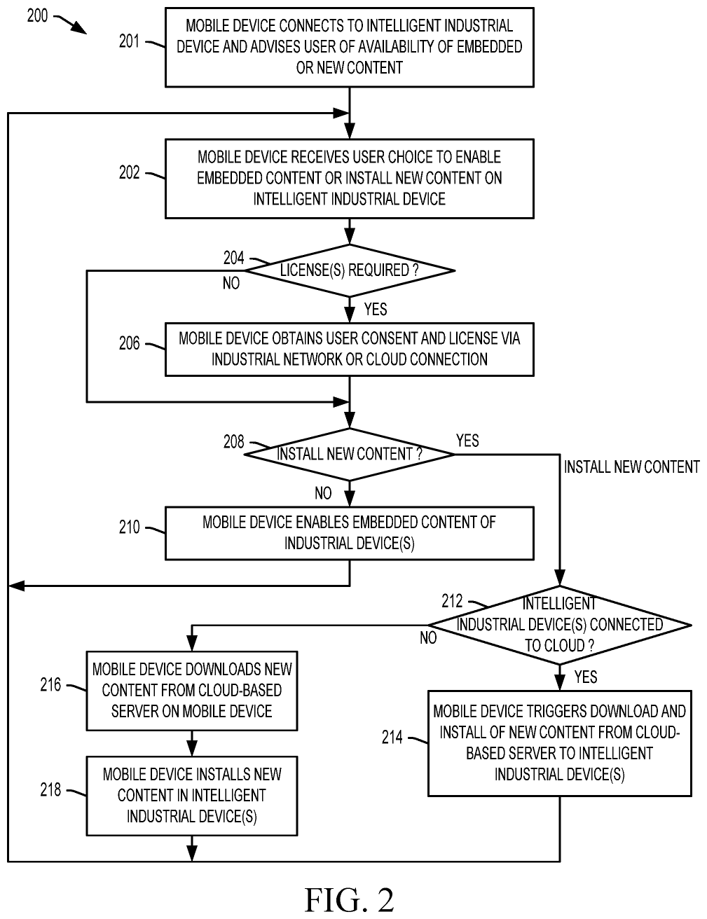

FIG. 2 shows a method 200 that can be implemented, in whole or in part, using the mobile device 120 and the industrial system 100 in one example. At 201 in FIG. 2, the mobile device 120 is configured with suitable program instructions (e.g., program 126 in FIG. 1B above) and establishes a communications connection to a first intelligent industrial device 102 of the industrial system 100 via the industrial network 101 and advises the user of the availability of new or embedded content. At 202, the mobile device 120 receives a user choice to enable embedded content (e.g., embedded content 130 in FIG. 1) and/or to install new content (e.g., new content 140 in FIG. 1) on and/or in the first intelligent industrial device 102.

In one example, the mobile device 120 determines at 204 whether a license is required for the selected embedded content 130 or new content 140. In one implementation, the mobile device 102 includes program instructions 126 and data 129 that determine whether or not a license is required at 204. In another non-limiting implementation, the mobile device 120 consults the cloud-based server 109 (FIG. 1) to determine whether or not a license is required at 204.

If a license is required (YES at 204), the mobile device 120 obtains user consent at 206 in FIG. 2 and obtains the license via the industrial network 101 and/or via the cloud connection 108. In one example, the mobile device 120 obtains the license at 206 for the embedded content 130 or the new content 140 via the cloud connection 108 and an industrial network 101 of the industrial system 100. In this or another example, the mobile device 120 obtains the license at 206 for the embedded content 130 or the new content 140 via a cellular connection 131 and the cloud connection 108.

Once the license has been obtained at 206, or if no license is required (NO at 204), the mobile device 120 determines at 208 whether the request is for installation of new content 140 or if the request is for enablement of embedded content 130. If no new content 140 is to be installed (NO at 208), the mobile device 120 enables the embedded content 130 of the intelligent industrial device 102 at 210 in FIG. 2, and the method 200 proceeds to await another user choice for enablement of embedded content 130 or installation of new content 140 at 202 as described above.

If installation of new content 140 has been requested (YES at 208 in FIG. 2), the mobile device 120 installs the new content 140, directly or indirectly. In one implementation, the mobile device 120 determines at 212 whether the intelligent industrial device 102 is connected to the cloud, for example, through the industrial network 101 and the cloud connection 108 in FIG. 1. If so (YES at 212), the mobile device 120 installs the new content 140 at 214 by triggering a download and installation of the new content 140 from the cloud-based server 109 to the intelligent industrial device 102. If the intelligent industrial device 102 is not connected to the cloud (NO at 212), the mobile device 120 installs the new content 114 at 216 and 218 in FIG. 2. In one example, the mobile device 120 downloads the new content 140 at 216 from the cloud-based server 109 to the mobile device 120, either beforehand, or as part of the new content installation, and the mobile device 120 installs the new content 140 on the intelligent industrial device 102 at 218. Thereafter, the method 200 returns to await another user choice for enablement of embedded content 130 or installation of new content 140 at 202 as described above.

In the above or other implementations, the mobile device 120 can implement batch enablement of embedded content 130 and/or installation of new content 140. For example, the mobile device 120 can obtain a second license at 206 for enabling embedded content 130 or installing new content 140 of a second intelligent industrial device 102 of the industrial system 100 and can do the same for more than two intelligent industrial devices 102 of the industrial system 100. In this example at 210 in FIG. 2, the mobile device 120 enables embedded content 130 and/or installs the new content 140 of the first intelligent industrial device 102 and enables the embedded content 130 and/or installs the new content 140 of the second intelligent industrial device 102, and any requested further intelligent industrial devices 102 of the industrial system 100.

Various embodiments have been described with reference to the accompanying drawings. Modifications and changes may be made thereto, and additional embodiments may be implemented, without departing from the broader scope of the invention as set forth in the claims that follow. The specification and drawings are accordingly to be regarded in an illustrative rather than restrictive sense. The above examples are merely illustrative of several possible embodiments of various aspects of the present disclosure, wherein equivalent alterations and/or modifications will occur to others skilled in the art upon reading and understanding this specification and the annexed drawings. In addition, although a particular feature of the disclosure may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

The following is claimed:

1. A method, comprising:
connecting a mobile device to an intelligent industrial device of an industrial system;
using the mobile device, one of:
enabling embedded content of the intelligent industrial device; and
installing new content in the intelligent industrial device.

2. The method of claim 1, further comprising:
using the mobile device, obtaining a license for the embedded content or the new content of the intelligent industrial device.

3. The method of claim 2, wherein the mobile device obtains the license for the embedded content or the new content via a cloud connection.

4. The method of claim 3, wherein the mobile device obtains the license for the embedded content or the new content via the cloud connection and an industrial network of the industrial system.

5. The method of claim 3, wherein the mobile device obtains the license for the embedded content or the new content via a cellular connection and the cloud connection.

6. The method of claim 2, further comprising:
using the mobile device, obtaining a second license for embedded content or new content of a second intelligent industrial device;
using the mobile device, enabling embedded content of the intelligent industrial device; and
using the mobile device, enabling embedded content of the second intelligent industrial device.

7. The method of claim 2, further comprising:
using the mobile device, obtaining a second license for embedded content or new content of a second intelligent industrial device;
using the mobile device, installing the new content in the intelligent industrial device; and
using the mobile device, installing the new content in the second intelligent industrial device.

8. The method of claim 7, further comprising:
using the mobile device, triggering a download of the new content from a cloud server to the intelligent industrial device and installation of the new content in the intelligent industrial device; and
using the mobile device, triggering a download of the new content from the cloud server to the second intelligent industrial device and installation of the new content in the second intelligent industrial device.

9. The method of claim 7, further comprising:
using the mobile device, downloading the new content from a cloud server to the mobile device;
using the mobile device, installing the new content in the intelligent industrial device; and
using the mobile device, installing the new content in the second intelligent industrial device.

10. The method of claim 1, comprising, using the mobile device, enabling embedded content of the intelligent industrial device.

11. The method of claim 2, comprising, using the mobile device, installing the new content in the intelligent industrial device.

12. The method of claim 11, further comprising:
using the mobile device, triggering a download of the new content from a cloud server to the intelligent industrial device and installation of the new content in the intelligent industrial device.

13. The method of claim 11, further comprising:
using the mobile device, downloading the new content from a cloud server to the mobile device; and
using the mobile device, installing the new content in the intelligent industrial device.

14. The method of claim 1, further comprising:
using the mobile device, enabling embedded content of the intelligent industrial device; and
using the mobile device, enabling embedded content of a second intelligent industrial device.

15. The method of claim 1, further comprising:
using the mobile device, installing the new content in the intelligent industrial device; and
using the mobile device, installing the new content in a second intelligent industrial device.

16. A non-transitory computer readable medium having computer executable instructions which, when executed by a processor of a mobile device connected to an industrial network of an industrial system, cause the mobile device to:
enable embedded content of an intelligent industrial device of the industrial system; or
install new content in the intelligent industrial device.

17. The non-transitory computer readable medium of claim 16, having computer executable instructions which, when executed by the processor, cause the mobile device to obtain a license for the embedded content or the new content of the intelligent industrial device.

18. The non-transitory computer readable medium of claim 16, having computer executable instructions which, when executed by the processor, cause the mobile device to enable embedded content of the intelligent industrial device.

19. The non-transitory computer readable medium of claim 16, having computer executable instructions which, when executed by the processor, cause the mobile device to install the new content in the intelligent industrial device.

20. A mobile device, comprising:
a memory that stores executable components; and
a processor operatively coupled to the memory and configured to execute the executable components, the executable components comprising: a communications component that communicates with an intelligent industrial device of an industrial system via a human interface module or a wireless access point or an industrial network of the industrial system; and a content component that installs or triggers installation of new content to the intelligent industrial device or enables embedded content of the intelligent industrial device.
